(19) United States
(12) Patent Application Publication
(10) Pub. No.: US 2018/0370481 A1
(43) Pub. Date: Dec. 27, 2018

(54) 3-Point convertible seat belt anchor assembly

(71) Applicant: Billy Gene Morris, Greer, SC (US)

(72) Inventor: Billy Gene Morris, Greer, SC (US)

(21) Appl. No.: 15/731,534

(22) Filed: Jun. 26, 2017

(51) Int. Cl. B60R 22/24

(52) U.S. Cl. CPC B60R 22/24

(57) ABSTRACT

The 3-Point Convertible Seat Belt Anchor Assembly is unique because the bracket's design facilitates the ability to mount a 3-point retractable seat belt system. The webbing of the seat belt will rest higher on the shoulder of the passenger(s), creating a safer angle across the torso which will restrain the passenger(s) in the event of a vehicular collision.

### BACKGROUND OF THE INVENTION

Three-Point Convertible Seat Belt Anchor Assembly creates the third shoulder mounting anchor point for the 3-point seat belt system in 1966-72 GM makes and models of classic cars.

### BRIEF SUMMARY OF INVENTION

Creates a bolt-in seat belt anchor mounting location above the shoulder for 1966-72 GM convertible cars, which only had a 2-point seat belt assembly and did not include an anchor point above the shoulder for a 3-point seat belt system when they were assembled in the factory. The bracket provides the third anchor point above the shoulder for the seat belt webbing mount to attach in the structure of the car, which will accommodate a 3-point seat belt system as the seat belt webbing goes over the passenger's shoulder and chest.

### BRIEF DESCRIPTION OF THE SEVERAL VIEWS OF THE DRAWING

FIG. 1. Drawing 170102-01 depicts the top view of the seat belt anchor brackets for GM A-body and similar automobiles.

FIG. 2. Drawing 170102-01 depicts the side view of the seat belt anchor brackets for GM A-body and similar automobiles.

FIG. 3. Drawing 170102-02 depicts the top view of the seat belt anchor brackets for GM F-body and similar automobiles.

FIG. 4. Drawing 170102-02 depicts the side view of the seat belt anchor brackets for GM F-body and similar automobiles.

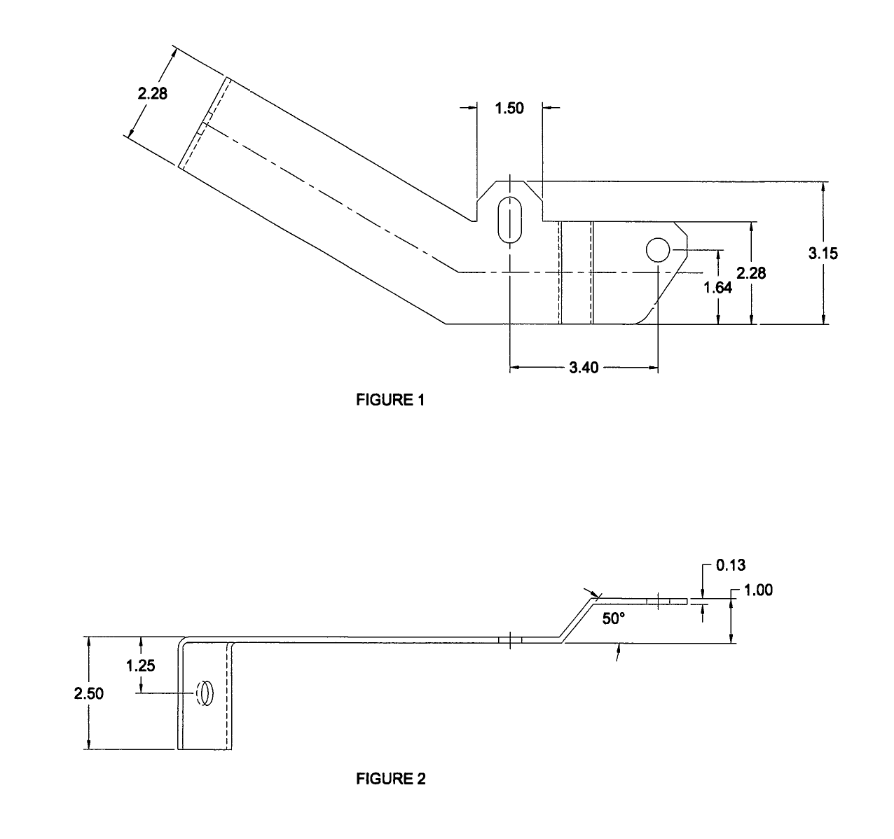

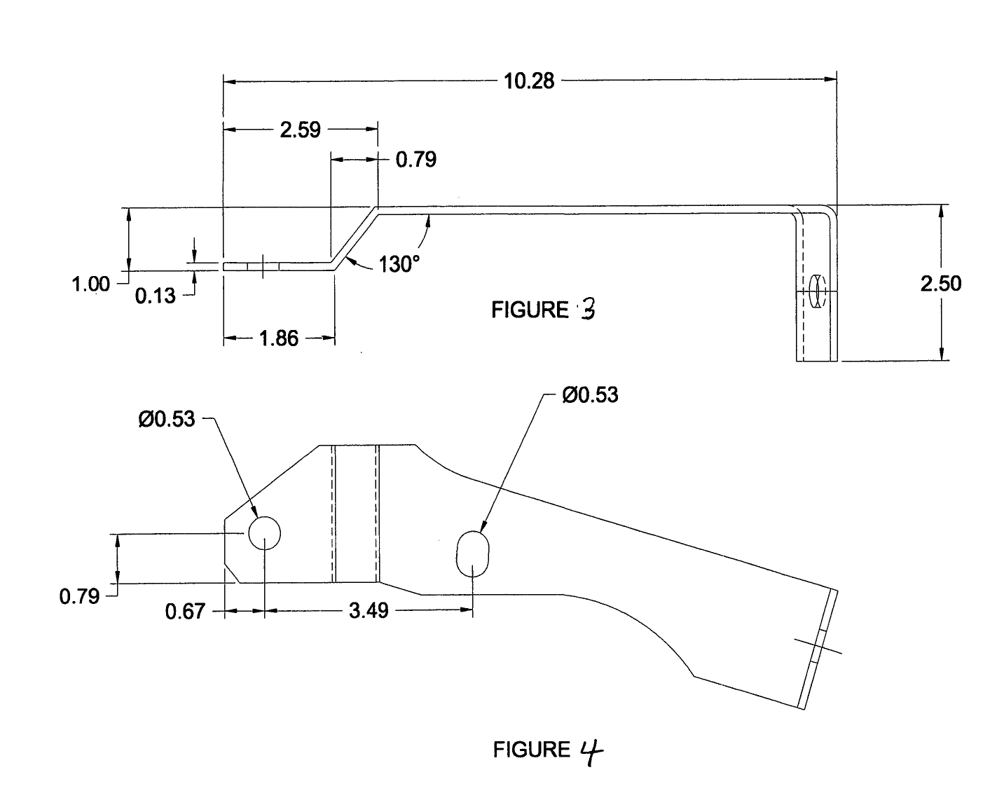

### DETAILED DESCRIPTION OF THE INVENTION

The 3-Point Convertible Seat Belt Anchor Assembly is laser cut from stainless steel, or carbon steel, and bent to specific dimensions on a metal brake machine. The Seat Belt Anchor Assembly is bolted into the structure of the vehicle, providing the third point for a 3-point seat belt system, as many cars from this era only had a 2-point seat belt assembly.

1. An article of invention for the 3-Point Convertible Seat Belt Anchor Assembly, which provides a mounting connection point for a 3-point Seat belt anchoring system.
